(19) United States
(12) Patent Application Publication
(10) Pub. No.: US 2017/0182533 A1
(43) Pub. Date: Jun. 29, 2017

(54) ROLLER FOR MANUFACTURING MAGNETIC SHEET AND MANUFACTURING METHOD OF MAGNETIC SHEET

(71) Applicant: SAMSUNG ELECTRO-MECHANICS CO., LTD., Suwon-si (KR)

(72) Inventors: Seung Min LEE, Suwon-si (KR); Jung Young CHO, Suwon-si (KR); Doo Ho PARK, Suwon-si (KR); Sung Nam CHO, Suwon-si (KR); Jung Wook SEO, Suwon-si (KR)

(73) Assignee: SAMSUNG ELECTRO-MECHANICS CO., LTD., Suwon-si (KR)

(21) Appl. No.: 15/232,195

(22) Filed: Aug. 9, 2016

(30) Foreign Application Priority Data
Dec. 28, 2015 (KR) 10-2015-0187775

(51) Int. Cl. B21B 1/22; H01F 41/32; H02J 7/02

(52) U.S. Cl. CPC B21B 1/22; H02J 7/025; H01F 41/32

(57) ABSTRACT

A method for manufacturing a magnetic sheet includes applying a roller having protrusions to a surface of a magnetic sheet to form recesses in the magnetic sheet. Functional regions having different degrees of compression are formed in the surface of the magnetic sheet by applying the roller.

### CROSS-REFERENCE TO RELATED APPLICATION

This application claims the benefit under 35 USC 119(a) of Korean Patent Application No. 10-2015-0187775 filed on Dec. 28, 2015, with the Korean Intellectual Property Office, the entire disclosure of which is incorporated herein by reference for all purposes.

### BACKGROUND

1. Field

The following description relates to a roller for manufacturing a magnetic sheet and a manufacturing method of magnetic sheet.

2. Description of Related Art

Recently, functions such as wireless power charging (WPC), near field communications (NFC), and magnetic secure transmission (MST) have been adopted for use in mobile terminals. There are differences in operating frequencies, data rates, and amounts of transmitted power between wireless power charging (WPC) technology, near field communications (NFC) technology, and magnetic secure transmission (MST) technology.

Due to the miniaturization and reduction of weight of electronic devices, it has been important to utilize all available space at the time of performing wireless power charging (WPC), near field communications (NFC), and the magnetic secure transmission (MST). However, since the operating frequencies of the wireless power charging (WPC) technology, near field communications (NFC) technology, and magnetic secure transmission (MST) technology are different from each other and permeabilities of shielding parts required for use therewith are different from each other, shielding may be difficult. Therefore, respective magnetic sheets formed of different magnetic materials should be used.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method for manufacturing a magnetic sheet includes applying a roller having protrusions to a surface of a magnetic sheet to form recesses in the magnetic sheet. Functional regions, each having different degrees of compression, are formed in the surface of the magnetic sheet by applying the roller.

Spacing, sizes, or shapes of the recesses, or any combination thereof, may be different from each other in at least two of the functional regions.

Heights of the recesses may be different from each other in at least two of the functional regions.

Inclinations of the recesses may be different from each other in at least two of the functional regions.

One of the functional regions may have a different magnetic permeability that of another functional region.

The functional regions may include first, second, and third regions, each having a different magnetic permeability. The first region may be a shielding part for wireless power charging, the second region may be a shielding part for magnetic secure transmission, and the third region may be a shielding part for near field communications.

The roller may further form a flat region without recesses, adjacent to the functional regions on the surface of the magnetic sheet.

A single full rotation of the roller along to magnetic sheet may form the functional regions.

In another general aspect, a roller for manufacturing a magnetic sheet includes a rotatable body, and protrusion regions formed on a surface of the rotatable body and comprising protrusions. The spacing, sizes, or shapes, or any combination thereof, of the protrusions in one of the protrusion regions are different from another protrusion region.

The protrusion regions may be disposed adjacent to each other and concentric.

The protrusion may have a tetrahedral shape or a conical shape.

A flat region without protrusions may be formed on the surface of the rotatable body.

The protrusion regions may form one group, and a plurality of groups are disposed on the rotatable body.

The group may have a rectangular shape when projected on a two dimensional plane.

The plurality of groups may be disposed to be adjacent to each other, and a flat region without protrusions may formed between the plurality of groups.

The plurality of groups may have the same shape as each other.

At least two of the plurality of groups may have different shapes from each other.

The protrusions in one group may have different spacing, shapes, or sizes, or any combination thereof, than protrusions in another group of the plurality of groups.

In another general aspect, a roller includes a rotatable body, protrusion groups adjacently formed on a surface of the rotatable body, including concentric protrusion regions. The spacing, sizes, or shapes, or any combination thereof, of protrusions in one of the protrusion regions are different from other protrusion regions.

Protrusion regions of one protrusion group may be different from the protrusion regions of another protrusion group. The protrusion regions of the one protrusion group may include first protrusions with a different spacing, size, or shape than second protrusions of the protrusion regions of the other protrusion group.

Other features and aspects will be apparent from the following detailed description, the drawings, and the claims.

### BRIEF DESCRIPTION OF DRAWINGS

FIG. 1 is a perspective view illustrating an exterior of an example wireless power charging system;

FIG. 2 is an exploded cross-sectional view illustrating main internal configurations of FIG. 1;

FIG. 3, a perspective view of a method for manufacturing a magnetic sheet according to an embodiment, schematically illustrating a process of applying a roller on a surface of the magnetic sheet to form recesses;

FIG. 4 is a plan view illustrating a plurality of protrusions according to an embodiment as illustrated in FIG. 3;

FIG. 5 is an enlarged view of part A of FIG. 4;

FIG. 6 is a cross-sectional view schematically illustrating a shape of a recess formed in the magnetic sheet;

FIG. 7 illustrates protrusions of the roller according to one or more embodiments;

FIGS. 8A through 8C illustrate shapes of a protrusion according to one or more embodiments;

FIGS. 9A and 9B illustrate protrusions of a roller according to one or more embodiments; and

FIGS. 10 through 12 illustrate shapes of surface protrusions of a roller according to one or more embodiments.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the embodiments.

Words describing relative spatial relationships, such as “below”, “beneath”, “under”, “lower”, “bottom”, “above”, “over”, “upper”, “top”, “left”, and “right”, may be used to conveniently describe spatial relationships of one device or elements with other devices or elements. Such words are to be interpreted as encompassing a device oriented as illustrated in the drawings, and in other orientations in use or operation. For example, an example in which a device includes a second layer disposed above a first layer based on the orientation of the device illustrated in the drawings also encompasses the device when the device is flipped upside down in use or operation.

The terminology used herein is for describing particular embodiments only and is not intended to be limiting of the present disclosure. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

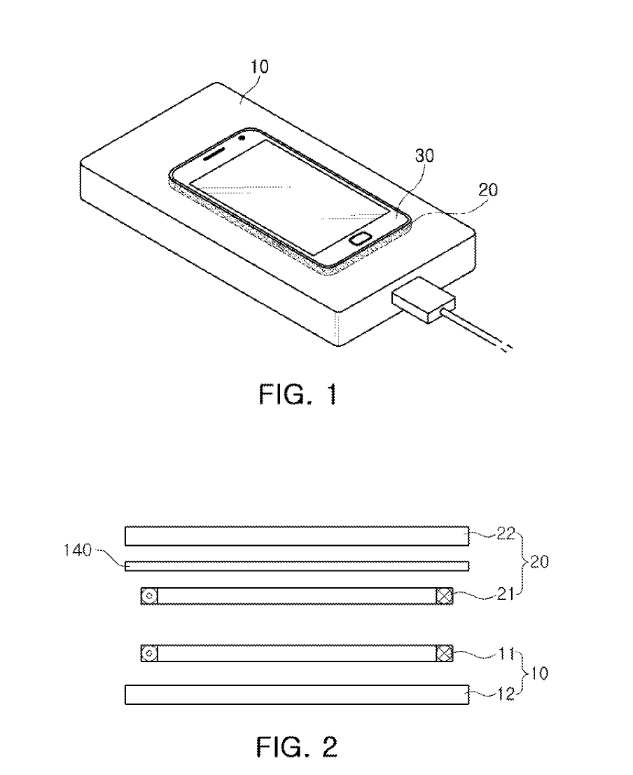

FIG. 1 is a perspective view schematically illustrating an exterior of an example wireless power charging system, and FIG. 2 is an exploded cross-sectional view illustrating main internal configurations of FIG. 1.

Referring to FIGS. 1 and 2, the wireless power charging system includes a wireless power transmission device 10 and a wireless power reception device 20. The wireless power reception device 20 is disposed in an electronic device 30 such as a portable phone, a notebook PC, or a tablet PC.

The interior of the wireless power transmission device 10 includes a transmitter coil 11 formed on a substrate 12, such that when an alternating current (AC) voltage is applied to the wireless power transmission device 10, a magnetic field may be formed around the transmitter coil 11. Therefore, electromotive force induced from the transmitter coil 11 may be generated in a receiver coil 21 embedded in the wireless power reception device 20, such that a battery 22 may be charged.

The battery 22 may be a rechargeable nickel hydrogen battery or lithium ion battery, but is not limited thereto. Further, the battery 22 may be configured separately to the wireless power reception device 20 to thereby be detachable from the wireless power reception device 20. Alternatively, the battery 22 and the wireless power reception device 20 may be integrated with each other.

When the wireless power reception device 20 is in close proximity to the wireless power transmission device and the AC voltage is applied to the wireless transmission device, the transmitter coil 11 and the receiver coil 12 are electromagnetically coupled to each other. The transmitter coil 11 and the receiver coil 21 may be formed by winding a metal wire such as a copper wire. In this case, the metal wire may be wound in a circular shape, an oval shape, a rectangular shape, or a trapezoidal shape, and an overall size or number of turns of the metal wire may be determined and set according to desired characteristics.

A magnetic sheet 140 is disposed between the receiver coil 21 and the battery 22. The magnetic sheet 140 is positioned between the receiver coil 21 and the battery 22 to absorb magnetic field, thereby allowing power to be efficiently received in the receiver coil 21. In addition, the magnetic sheet 140 may block at least a portion of the magnetic field from reaching the battery 22.

Although the wireless power charging system is described in FIG. 2, a near field communications (NFC) system, and a magnetic secure transmission (MST) system may include a transmission device and a reception device with a magnetic sheet disposed between a receiver coil and a battery in the reception device similar to the transmission device 10, the reception device 20 and magnetic sheet 140 of FIG. 2.

In this case, in order to utilize a space, a wireless power charging coil and a near field communications coil may be mounted adjacent to each other on a single substrate and may be simultaneously used. However, since the operating frequencies of the wireless power charging (WPC) technology, the near field communications (NFC) technology, and the magnetic secure transmission (MST) technology are different from each other, the permeabilities of the shielding parts are also different from each other. Therefore, the magnetic sheets should be formed of different magnetic materials For example, generally, in a case of near field communications, a ferritic magnetic sheet may be used as a shielding part, and in the cases of wireless power charging and magnetic secure transmissions, a metal ribbon magnetic sheet may be used as a shielding part.

Therefore, since both types of magnetic sheets are used separately, the magnetic sheets may occupy a large space. Additionally, combining magnetic sheets formed of different materials through a sintering process may be relatively complicated, and the number of processes required may be increased.

Therefore, according to an embodiment, recesses are formed in a single magnetic sheet so that functional regions having different degrees of compression, e.g. angle of inclination of the recesses, from each other are formed. A surface shape of a roller for forming the recesses corresponds to the plurality of functional regions. The magnetic sheet as described above may be used in various frequency ranges. For example, the magnetic sheet may be simultaneously applied to a shielding part for wireless power charging and a shielding part for near field communications. Further, the magnetic sheet may optimize transmission efficiency in each of the operating frequencies of wireless power charging, and near field communications thereby improving communications efficiency.

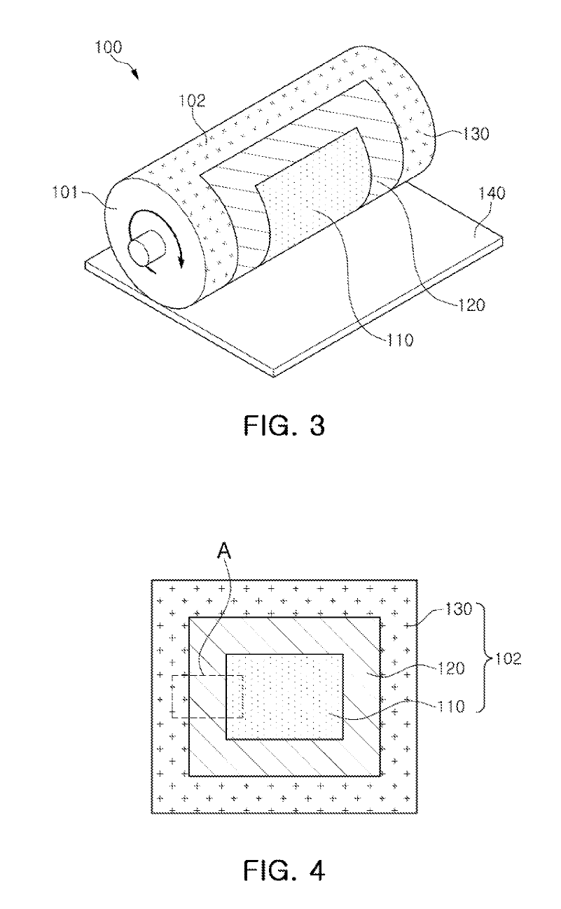

FIG. 3, a perspective view of a method for manufacturing a magnetic sheet according to an embodiment, schematically illustrates a process of applying a roller 100 to a surface of the magnetic sheet 140 to form recesses.

As described above, the magnetic sheet 140 is used in an electronic product for wireless power charging, or near field communications, and used in order to shield electromagnetic waves or absorb a magnetic field. To this end, the magnetic sheet 140 may be formed of a sintered ferrite sheet, a thin film metal ribbon formed of an amorphous alloy or nanocrystalline alloy, or any combination thereof. More specifically, in a case of using ferrite, the magnetic sheet 140 may be formed of a Mn—Zn based ferrite material, a Mn—Ni based ferrite material, a Ba based ferrite material, or a Sr based ferrite material, or any combination thereof, and these materials may be formed in a form of nanocrystalline powder.

Further, an example of the amorphous alloy usable as the magnetic sheet 140 may include an Fe based magnetic alloy or a Co based magnetic alloy. In this case, as the Fe based magnetic alloy, for example, a Fe—Si—B alloy may be used. As a percentage of a metal, including Fe, is increased, a saturation magnetic flux density is also increased. But in a case in which a content of Fe is excessively high, it may be difficult to form the amorphous alloy. Therefore, the amount of Fe may be 70 to 90 atomic percent and a sum of Si and B that is present is in a range of 10 to 30 atomic percent. In this case, a glass forming ability of the alloy may be excellent. An anti-corrosive element such as chromium (Cr) or cobalt (Co) may be added to a basic composition as described above up to 20 atomic percent in order to prevent corrosion. If desired, a small amount of another metal element may be included in order to further impart other characteristics. In one example, a nanocrystalline alloy is used in the magnetic sheet 140, such as, a Fe based nanocrystalline metal alloy. In this case, a Fe—Si—B—Cu—Nb alloy may be used as the Fe based nanocrystalline alloy.

The roller 100 forms the recesses in the magnetic sheet 140, and includes a rotatable body 101. A plurality of protrusion regions 110, 120, and 130 having protrusions is formed on a surface of the body 101. Thus, the recesses are formed in the magnetic sheet 140 while the body 101 rotates along the magnetic sheet 140. In this case, the plurality of protrusion regions 110, 120, and 130 form a group 102 corresponding to one magnetic sheet 140.

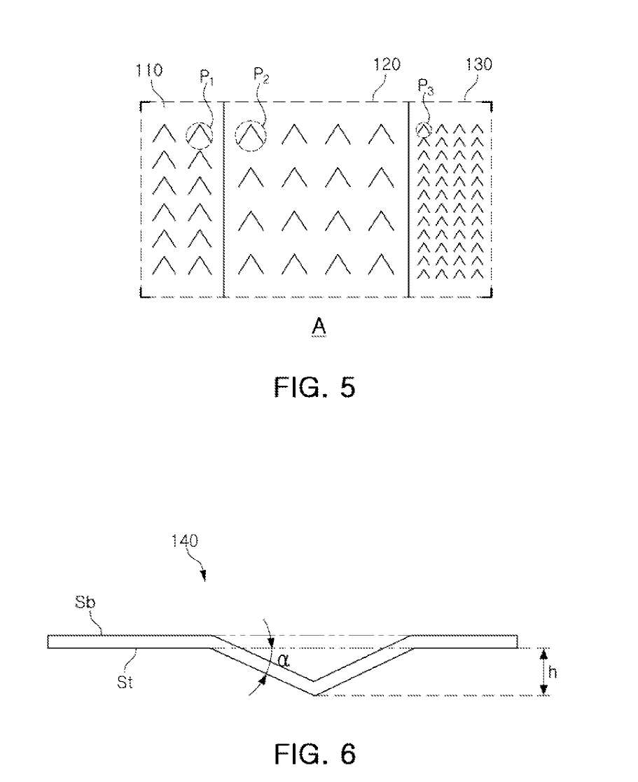

The plurality of protrusion regions 110, 120, and 130 are described in more detail with reference to FIGS. 4 through 6. FIG. 4 is a plan view illustrating a plurality of protrusions in an embodiment illustrated in FIG. 3, and FIG. 5 is an enlarged view of part A of FIG. 4. In addition, FIG. 6 is a cross-sectional view schematically illustrating a shape of a recess formed in the magnetic sheet by the roller 100.

Each protrusion region 110, 120, and 130 includes corresponding protrusions P1, P2, and P3, respectively. The spacing, sizes, or shapes of the protrusions P1, P2, and P3, may be different from each other. Thus, the shielding characteristics of each of the plurality of protrusion regions, for example, may have different levels of permeability from each other. A case in which the intervals between the protrusions P1, P2, and P3 included in the regions 110, 120, and 130, respectively, are different from each other is illustrated in FIG. 3. In this case, as illustrated in FIG. 3, the plurality of protrusion regions 110, 120, and 130 are adjacent to each other and arranged concentrically. Further, the group 102 formed by the plurality of protrusion regions 110, 120, and 130 may have a rectangular shape. The above description the plurality of protrusions 110, 120, and 130 is only an example for effectively implementing a multi-functional magnetic sheet 140.

The roller 100 is applied to the magnetic sheet 140 to form recesses in the magnetic sheet 140 having shapes corresponding to the protrusions P1, P2, and P3 in the plurality of protrusion regions 110, 120, and 130. Thus, a plurality of functional regions, corresponding to the protrusion regions 110, 120, and 130, of which degrees of compression are different from each other are formed in the magnetic sheet 140. In detail, at least two of the plurality of functional regions have different spacing, sizes and shapes of the recesses from each other. According to one or more embodiments, three functional regions are formed to correspond to three protrusions 110, 120, and 130, and the interval, or spacing, between the recesses in each of the respective functional groups are different from each other.

As described above, the sizes and shapes of the recesses formed in the magnetic sheet 140 may also be changed according to each of the functional regions, as well as the interval between the recesses. FIG. 6 illustrates a height h and an inclination a based on one recess. As described above, in the magnetic sheet 140 to which the roller 100 is applied, the surface may be nano-crystalline, thereby forming the recesses having a stereoscopic, or three-dimensional, structure protruding from one surface St of the magnetic sheet 140. The recesses as described above have a stereoscopic structure of which a height from one surface St of the magnetic sheet 140 is decreased from a maximum height h to an edge of the recess. Further, the degree of compression corresponds to an inclination a from an edge of the recess to the maximum height h and the maximum height h.

As described above, the recess protrudes from one surface St of the magnetic sheet 140, creating an embossed surface, and has a debossed stereoscopic structure on the other surface Sb of the magnetic sheet 140. That is, the recesses have a structure protruding from one surface St of the magnetic sheet 140 and have a structure depressed from the other surface Sb of the magnetic sheet 140.

When the degrees of compression of the respective functional regions of the magnetic sheet are different from each other, the magnetic properties of the respective functional regions, for example, permeabilities and core losses are different from each other. Thus, the transmission efficiency at each corresponding operating frequency may be optimized. Therefore, due to the shape as described above, the magnetic sheet 140, obtained by the method according to one or more embodiments, may be simultaneously applied as a shielding part for wireless power charging and near field communications having different operating frequencies. Thus, the transmission efficiency at each of the operating frequencies may be optimized.

In detail, the operation frequency in wireless power charging may be in a range of about 110 kHz to 205 kHz, the operation frequency in near field communications may be about 13.56 MHz, the operation frequency in magnetic secure transmission may be about 70 kHz, and the operation frequency in Power Matters Alliance standard (PMA) may be in a range of about 275 kHz to 357 kHz.

For example, when the functional regions of the magnetic sheet 140 formed to correspond to the plurality of protrusion regions 110, 120, and 130 are defined as first, second, and third regions, respectively. The first region may be a shielding part for wireless power charging, the second region may be a shielding part for magnetic secure transmission, and the third region may be a shielding part for near field communications. However, each of the functional regions in the magnetic sheet 140 may be configured to shield any frequency band. To this end, the sizes, shapes, positions, number, or spacing, or any combination thereof, of the protrusions in each protrusion region of the roller 100 may be changed accordingly. Further, although a case in which the roller 100 has three protrusion regions 110, 120, and 130 is described above, the number of protrusion regions may also be two, or four or more.

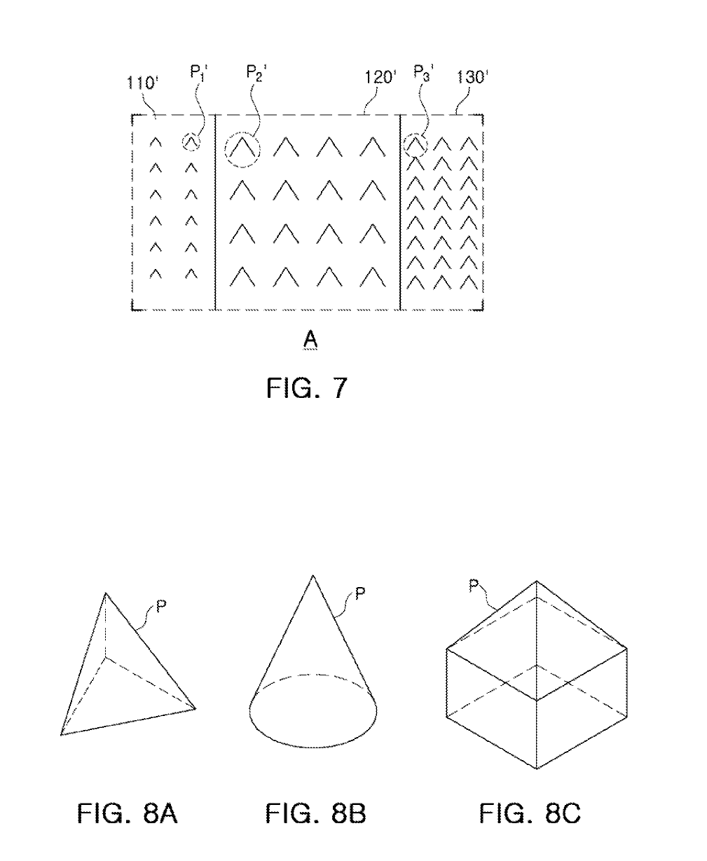

FIG. 7 illustrates protrusions adoptable in a modified example of the roller according to the exemplary embodiment illustrated in FIG. 3. In addition, FIGS. 8A through 8C illustrate shapes of the protrusion adoptable in the exemplary embodiment in the present disclosure.

Referring to FIG. 7, in a plurality of protrusion regions 110′, 120′, and 130′ according to another example, the sizes of protrusions P1′, P2′, and P3′ are different from the embodiment described above with reference to FIG. 5. As the sizes of the protrusions are different from each other, corresponding recesses formed in respective functional regions of the magnetic sheet 140 have different heights h and inclinations a from each other. However, unlike the example illustrated in FIG. 7, only protrusions included in one of the plurality of protrusion regions 110, 120, and 130 of FIG. 5 has a different size from the other two protrusion regions 110 and 130. However, the size of each protrusion in each protrusion region may be adjusted depending on the desired characteristics of the functional regions.

Further, as illustrated in FIGS. 8A through 8C, the shape of the protrusion P of the roller 100 may be varied. The protrusion P may have a tetrahedral shape (see FIG. 8A), conical shape (see FIG. 8B) or a polyhedron or pyramid shape protruding from a cube base (see FIG. 8C). However, the protrusion P may also have any as long as the protrusion P may form a recess on the magnetic sheet. For example, the protrusion P may also have a hexahedral shape, or a polygonal pillar shape.

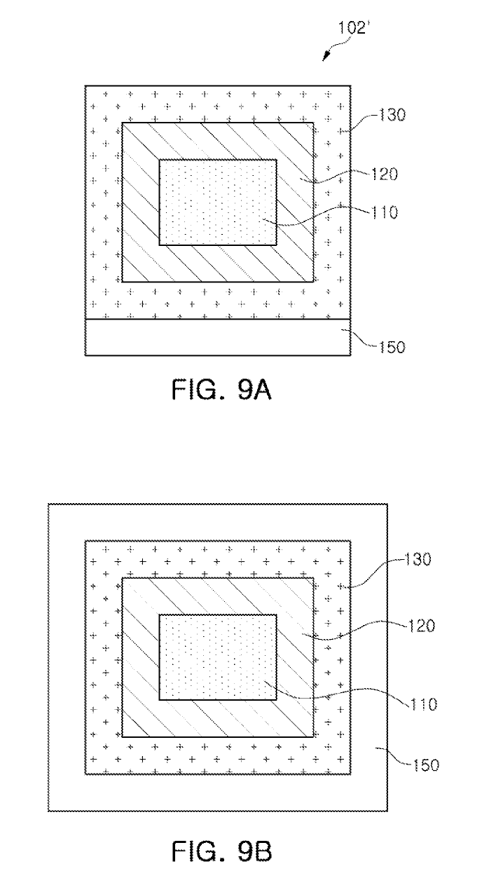

FIGS. 9A and 9B illustrate examples of the roller according to another embodiment. Referring to FIGS. 9A and 9B, a flat region 150 is included in a group 102′, in addition to the plurality of protrusion regions 110, 120, and 130. The flat region 150, as described above, is a region of a surface of a body of the roller on which protrusions are not formed. Thus a corresponding flat region without a recess is formed in the magnetic sheet 140. The corresponding flat region formed in the magnetic sheet 140 may improve bonding safety with a coil component when being applied to a product. Further, at the time of forming the recesses, the corresponding flat region aids in determining whether or not the recesses are suitably formed in each of the functional regions of the magnetic sheet 140. In this case, as illustrated in FIGS. 9A and 9B, the flat region 150 is adjacent to the plurality of protrusion regions 110, 120, and 130. For example, as illustrated in FIG. 9A, the flat region 150 is formed at sides of the plurality of protrusions 110, 120, and 130. Alternatively, as illustrated in FIG. 9B, the flat region 150 is concentric with and encloses the plurality of protrusion regions 110, 120, and 130.

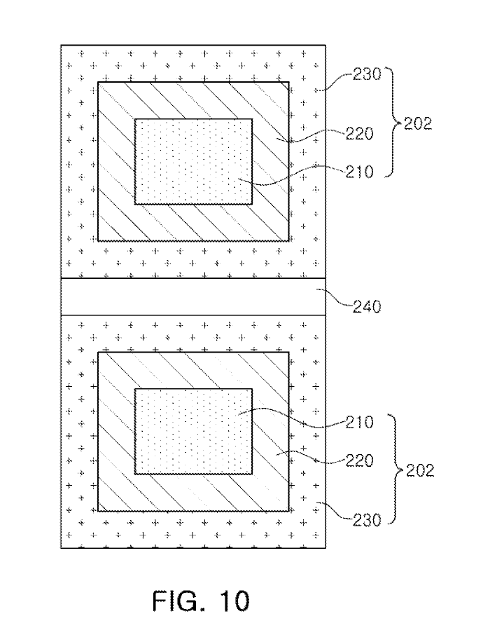

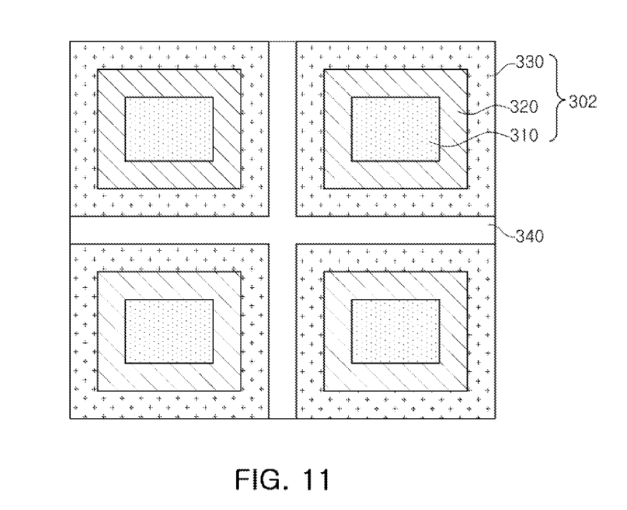

FIGS. 10 through 12 illustrate a roller according to another embodiment.

First, a case in which the number of groups 202 formed by a plurality of protrusion regions 210, 220, and 230 is two or more. Specifically, a case in which the number of groups 202 is two is illustrated in FIG. 10. In this case, the two groups 202 are disposed to be adjacent to each other, and a flat region 240 without protrusions is formed between the groups 202. A magnetic sheet 140 having a corresponding shape is formed by one full rotation of the roller along the magnetic sheet 140. In other words, the circumference of the roller corresponds to a length of the magnetic sheet 140. Thus, two groups of functional regions corresponding to the two groups of the protrusion regions 202 is formed in the magnetic sheet 140. In this case, the two groups of functional regions may be separated along the flat region 240, resulting in two shielding parts. Likewise, more than two functional regions can be simultaneously formed by one full rotation of the roller. Therefore, process efficiency for manufacturing the magnetic sheet may be improved.

A method for forming a plurality of magnetic sheet groups may be applied as a method capable of obtaining a larger number of groups as in the embodiment illustrated in FIG. 11. A case in which the number of groups 302 formed by a plurality of protrusion regions 310, 320, and 330 is four is illustrated in FIG. 11. A flat region 340 without protrusions is formed between the groups 302. In this case, four groups of functional regions may be formed by one full rotation of the roller along the magnetic sheet. The four groups of functional regions may be separated into four individual shield parts.

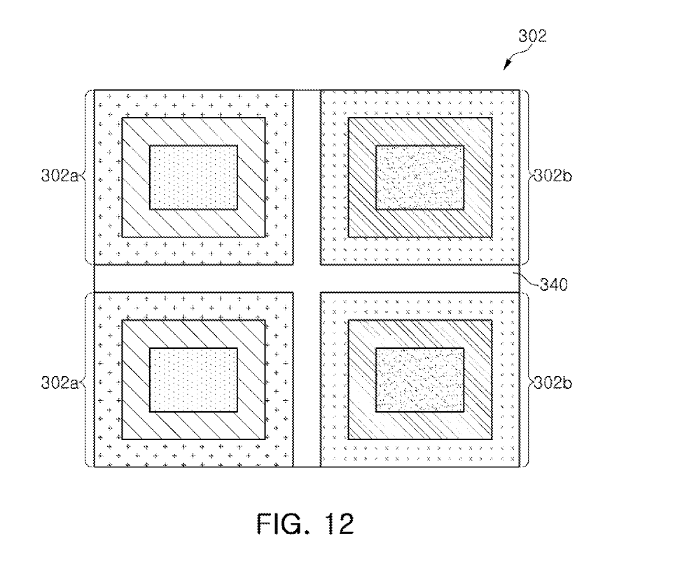

Although cases in which shapes of the protrusions included in each of the groups 202 and 302 are the same are illustrated in the embodiments illustrated in FIGS. 10 and 11, each group of protrusion regions may also have different shapes as in another embodiment illustrated in FIG. 12. That is, magnetic sheets having different frequency shielding bands and structures from each other may also be manufactured by one full rotation of the roller along a magnetic sheet. To this end, groups 302a and 302b having protrusions with different shapes, spacing, or sizes, or any combination thereof, from each other may be formed on the roller as illustrated in FIG. 12. Further, the protrusions may be variously disposed. For example, the protrusions having the same shape as each other may be disposed at different positions from each other.

As set forth above, according to one or more embodiments, a magnetic sheet capable of shielding various frequency ranges to optimize utilization of the space in the electronic product may be achieved, and a process for manufacturing the magnetic sheet may be simplified.

Further, the roller having a grouped protrusion structure for manufacturing the magnetic sheet as described above may be achieved, and the magnetic sheet on which recess structures having various shapes are formed may be effectively implemented by using the roller.

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

What is claimed is:

1. A method for manufacturing a magnetic sheet, the method comprising:
applying a roller having protrusions to a surface of a magnetic sheet to form recesses in the magnetic sheet,
wherein functional regions having different degrees of compression are formed in the surface of the magnetic sheet by applying the roller.

2. The method of claim 1, wherein spacing, sizes, or shapes of the recesses, or any combination thereof, are different from each other in at least two of the functional regions.

3. The method of claim 1, wherein heights of the recesses are different from each other in at least two of the functional regions.

4. The method of claim 1, wherein inclinations of the recesses are different from each other in at least two of the functional regions.

5. The method of claim 1, wherein one of the functional regions has a different magnetic permeability that of another functional region.

6. The method of claim 1, wherein the functional regions comprise first, second, and third regions, each having a different magnetic permeability,
the first region is a shielding part for wireless power charging, the second region is a shielding part for magnetic secure transmission, and the third region is a shielding part for near field communications.

7. The method of claim 1, wherein the roller further forms a flat region, without recesses, adjacent to the functional regions on the surface of the magnetic sheet.

8. The method of claim 1, wherein a single full rotation of the roller along to magnetic sheet forms the functional regions.

9. A roller for manufacturing a magnetic sheet, the roller comprising:
a rotatable body; and
protrusion regions formed on a surface of the rotatable body and comprising protrusions,
wherein spacing, sizes, or shapes, or any combination thereof, of the protrusions in one of the protrusion regions are different from another protrusion region.

10. The roller of claim 9, wherein the protrusion regions are disposed adjacent to each other, and concentric.

11. The roller of claim 9, wherein the protrusion has a tetrahedral shape or a conical shape.

12. The roller of claim 9, wherein the protrusion regions form one group, and a plurality of groups are disposed on the rotatable body.

13. The roller of claim 12, wherein the group has a rectangular shape when projected on a two dimensional plane.

14. The roller of claim 12, wherein the plurality of groups are disposed to be adjacent to each other, and a flat region without protrusions is formed between the plurality of groups.

15. The roller of claim 12, wherein the plurality of groups have the same shape as each other.

16. The roller of claim 12, wherein at least two of the plurality of groups have different shapes from each other.

17. The roller of claim 12, wherein the protrusions in one group have different spacing, shapes, or sizes, or any combination thereof, than protrusions in another group of the plurality of groups.

18. A roller comprising:
a rotatable body;
protrusion groups adjacently formed on a surface of the rotatable body comprising concentric protrusion regions,
wherein spacing, sizes, or shapes, or any combination thereof, of protrusions in one of the concentric protrusion regions are different from other protrusion regions.

19. The roller of claim 18, wherein the concentric protrusion regions of one protrusion group are different from the protrusion regions of another protrusion group.

20. The roller of claim 19, wherein the concentric protrusion regions of the one protrusion group comprises first protrusions with a different spacing, size, or shape than second protrusions of the protrusion regions of the other protrusion group.
